(19) United States
(12) Patent Application Publication
(10) Pub. No.: US 2023/0174282 A1
(43) Pub. Date: Jun. 8, 2023

(54) POUCH CONTAINER AND METHOD OF MANUFACTURING THE SAME

(71) Applicant: Fuji Seal, Inc., Osaka (JP)

(72) Inventors: Tadashi Takano, Osaka (JP); Masahiro Kaminaga, Osaka (JP)

(21) Appl. No.: 18/075,045

(22) Filed: Dec. 5, 2022

(30) Foreign Application Priority Data
Dec. 8, 2021 (JP) 2021-199477

(51) Int. Cl. B65D 75/26; B65D 75/56; B65D 75/58; B31B 70/81

(52) U.S. Cl. CPC B65D 75/26; B65D 75/563; B65D 75/5877; B31B 70/81; B65D 2575/586; B31B 2170/20

(57) ABSTRACT

A pouch container has a gas filling space therein, and includes a first wall section and a second wall section. The first wall section includes a first tongue-shaped portion. The second wall section includes a second tongue-shaped portion and overlapping the first tongue-shaped portion. A projection length of the second tongue-shaped portion is longer than that of the first tongue-shaped portion. A gas injection portion is provided in which an injection port communicating with the gas filling space is formed by joining both end portions of both the first tongue-shaped portion and the second tongue-shaped portion in a width direction, and the injection port is defined by a tip end portion of the first tongue-shaped portion in a projection direction and the second tongue-shaped portion at a portion facing the tip end portion.

### TECHNICAL FIELD

The present invention relates to a pouch container provided therein with a storage space for storing contents and a gas filling space that is a space different from the storage space, and a method of manufacturing the same.

### BACKGROUND ART

For example, JP 2021-31095 A (Patent Document 1) and JP 2015-24855 A (Patent Document 2) disclose pouch containers that have gas filling spaces therein for improving shape retention and cushioning properties.

### CITATION LIST

### Patent Literature

Patent Document 1: JP 2021-31095 A

Patent Document 2: JP 2015-24855 A

### SUMMARY OF INVENTION

### Technical Problem

Both of the pouch containers disclosed in Patent Documents 1 and 2 have a gas injection portion for injecting gas into the gas filling space. However, the injection of gas into the gas filling space provided in the pouch container is complicated. Thus, further facilitation of gas injection and facilitation of manufacturing of a pouch container are desired.

Accordingly, the present invention has been made to solve the problems described above, and an object of the present invention is to facilitate gas injection and facilitate manufacturing of a pouch container having a gas filling space therein.

### Solution to Problem

A pouch container according to the present invention is provided with a storage space for storing contents and a gas filling space that is a space different from the storage space therein, and includes a first wall section and a second wall section having a sheet-like shape and defining the storage space, and a seal portion formed by overlapping and joining an edge portion of the first wall section and an edge portion of the second wall section, and configured to seal the storage space from outside. At the edge portion of the first wall section and the edge portion of the second wall section at a portion where the seal portion is formed, a gas injection portion having a projection shape and formed with an injection port communicating with the gas filling space is provided. The first wall section includes a first tongue-shaped portion projecting outward from the edge portion of the first wall section at the portion where the seal portion is formed, and the second wall section includes a second tongue-shaped portion projecting outward from the edge portion of the second wall section at the portion where the seal portion is formed and overlapping the first tongue-shaped portion. The projection length of the second tongue-shaped portion is longer than the projection length of the first tongue-shaped portion. In the pouch container according to the present invention, the gas injection portion is formed by the first tongue-shaped portion and the second tongue-shaped portion by joining both end portions of both the first tongue-shaped portion and the second tongue-shaped portion that overlap each other in a width direction, and the injection port is defined by a tip end portion of the first tongue-shaped portion in a projection direction and the second tongue-shaped portion at a portion facing the tip end portion.

In the pouch container according to the present invention, both end portions of both the first tongue-shaped portion and the second tongue-shaped portion in the width direction may be joined only at root-side portions of the gas injection portion.

The pouch container according to the present invention may include a body section and a gusset section defining the storage space. In this case, one of the first wall section and the second wall section may be the gusset section, and another of the first wall section and the second wall section may be the body section.

In the pouch container according to the present invention, the gas filling space may include a first space located between the body section and the gusset section. In this case, the first space may be formed surrounded by the seal portion.

In the pouch container according to the present invention, the body section may include a front wall section and a rear wall section facing each other. In this case, the pouch container according to the present invention may further include a body-section-side seal portion formed by overlapping and joining both edge portions of both the front wall section and the rear wall section in a width direction. In addition, in this case, the gas filling space may further include a second space located between the front wall section and the rear wall section. Further, in this case, the second space may be formed surrounded by the body-section-side seal portion and may communicate with the first space at an end portion of the body-section-side seal portion on a side of the gusset section.

In a method of manufacturing a pouch container according to the present invention, a plurality of pouch containers, each of which is provided with a storage space for storing contents and a gas filling space that is a space different from the storage space therein, are continuously manufactured using a single belt-like film member including more than one portion to be a gusset section of each of the plurality of pouch containers and a plurality of tubular sheet film members, each of which includes at least a portion to be a body section of each of the plurality of pouch containers as materials. The method includes preparing the plurality of tubular sheet film members, transporting the single belt-like film member on a transport path along a longitudinal direction of the single belt-like film member, supplying each of the plurality of tubular sheet film members to the single belt-like film member being transported on the transport path, closing a gusset-section-side open end located at one end of each of the plurality of tubular sheet film members in an axis direction supplied to the single belt-like film member with the portion to be the gusset section of the single belt-like film member, and after the gusset-section-side open end is closed by the portion to be the gusset section of the single belt-like film member, forming the body section and the gusset section by cutting off an excess portion from a joint margin provided at the gusset-section-side open end and the portion to be the gusset section of the single belt-like film member.

In the supplying of each of the plurality of tubular sheet film members to the single belt-like film member, each of the plurality of tubular sheet film members is supplied in a state that the joint margin is expanded and the joint margin is overlapped with the portion to be the gusset section of the single belt-like film member. In the closing of a gusset-section-side open end by the portion to be the gusset section of the single belt-like film member, a seal portion is formed by joining an edge portion of the joint margin and an edge portion of the portion to be the gusset section of the single belt-like film member being overlapped.

In the forming of the body section and the gusset section by cutting off an excess portion, a gas injection portion is provided in which an injection port that communicates with the gas filling space at the edge portion of the body section and the edge portion of the gusset section at a portion where the seal portion is formed by a first tongue-shaped portion formed at an edge portion of one of the body section and the gusset section and projecting outward from the edge portion and a second tongue-shaped portion formed at an edge portion of the other of the body section and the gusset section, overlapping the first tongue-shaped portion by projecting outward from the edge portion, and having a projection length longer than a projection length of the first tongue-shaped portion.

In the method of manufacturing the pouch container according to the present invention, when the joint margin is superimposed on the portion to be the gusset section of the single belt-like film member, of the edge portion of the joint margin and the edge portion of the portion to be the gusset section of the single belt-like film member, the edge portion where the second tongue-shaped portion is formed is positioned outside the edge portion where the first tongue-shaped portion is formed, of the edge portion of the joint margin and the edge portion of the portion to be the gusset section of the single belt-like film member, and in the forming of the body section and the gusset section by cutting off an excess portion, by joining both end portions of both the first tongue-shaped portion and the second tongue-shaped portion that overlap each other in a width direction when the seal portion is formed, the injection port is defined by a tip end portion of the first tongue-shaped portion in a projection direction and the second tongue-shaped portion at a portion facing the tip end portion.

In the method of manufacturing the pouch container according to the present invention, in the closing of the gusset-section-side open end by the portion to be the gusset section of the single belt-like film member, both end portions of both the first tongue-shaped portion and the second tongue-shaped portion in the width direction may be joined only at root side portions of the gas injection portion.

In the method of manufacturing the pouch container according to the present invention, in the closing of the gusset-section-side open end by the portion to be the gusset section of the single belt-like film member, by forming the gas filling space surrounded by the seal portion, the gas filling space may include a first space located between the portion to be the body section of each of the plurality of tubular sheet film members and the portion to be the gusset section of the single belt-like film member.

In the method of manufacturing the pouch container according to the present invention, in the preparing of the plurality of tubular sheet film members, the body section of each of the plurality of tubular sheet film members may include a front wall section and a rear wall section facing each other, a body-section-side seal portion may be formed by overlapping and joining both edge portions of both the front wall section and the rear wall section in a width direction, and further, by forming the gas filling space surrounded by the body-section-side seal portion, the gas filling space may include a second space located between the front wall section and the rear wall section. In this case, in the closing of the gusset-section-side open end by the portion to be the gusset section of the single belt-like film member, the second space may communicate with the first space at an end portion of the body-section-side seal portion on a side of the gusset section.

### Advantageous Effects of Invention

According to the present invention, it is possible to facilitate gas injection and facilitate manufacture of a pouch container with a gas filling space therein.

### BRIEF DESCRIPTION OF DRAWINGS

FIG. 1 is a perspective view illustrating an external shape of a pouch container according to a first embodiment.

FIG. 2 is a front view of the pouch container illustrated in FIG. 1 in a folded state.

FIG. 3 is a diagram showing a manufacturing flow according to a method of manufacturing the pouch container according to the first embodiment.

FIG. 4 is a schematic perspective view for describing the method of manufacturing the pouch container according to the first embodiment.

FIG. 5 is a front view of a tubular sheet film member as a material for the pouch container according to the first embodiment.

FIG. 6 is a schematic perspective view for describing the method of manufacturing the pouch container according to the first embodiment.

FIG. 7 is a schematic cross-sectional view for describing the method of manufacturing the pouch container according to the first embodiment.

FIG. 8 is a schematic plan view for describing the method of manufacturing the pouch container according to the first embodiment.

FIG. 9 is a schematic cross-sectional view for describing the method of manufacturing the pouch container according to the first embodiment.

FIG. 10 is a schematic perspective view for describing the method of manufacturing the pouch container according to the first embodiment.

FIG. 11 is a schematic plan view for describing the method of manufacturing the pouch container according to the first embodiment.

FIG. 12 is a schematic plan view for describing the method of manufacturing the pouch container according to the first embodiment.

FIG. 13 is a schematic perspective view for describing the method of manufacturing the pouch container according to the first embodiment.

FIG. 14 is a front view of a pouch container in a folded state according to a first modified example.

FIG. 15 is a front view of a pouch container in a folded state according to a second embodiment.

FIG. 16 is a front view of a pouch container in a folded state according to a second modified example.

FIG. 17 is a front view of a pouch container in a folded state according to a third modified example.

FIG. 18 is a front view of a pouch container according to a third embodiment.

### DESCRIPTION OF EMBODIMENTS

Hereinafter, embodiments of the present invention will be described with reference to the figures. Note that in the embodiments illustrated below, identical or common portions are denoted by the same reference signs in the figures, and description thereof will not be repeated.

### First Embodiment

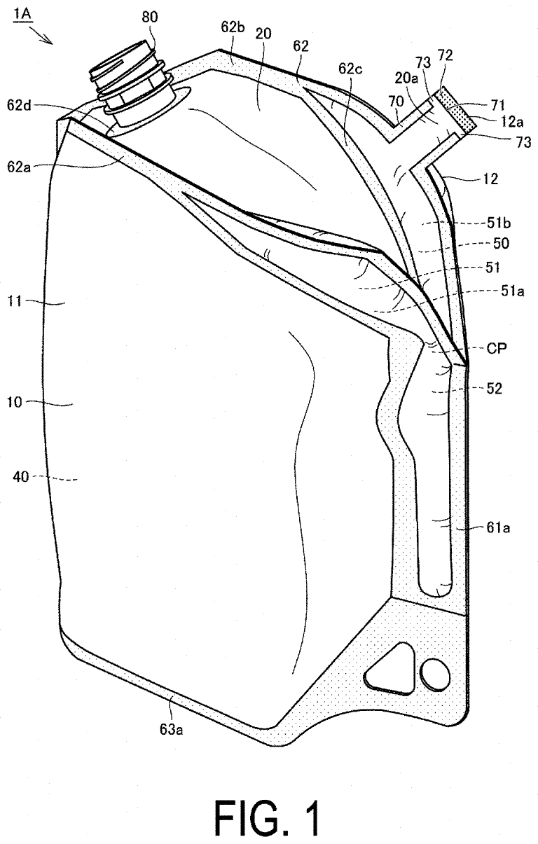

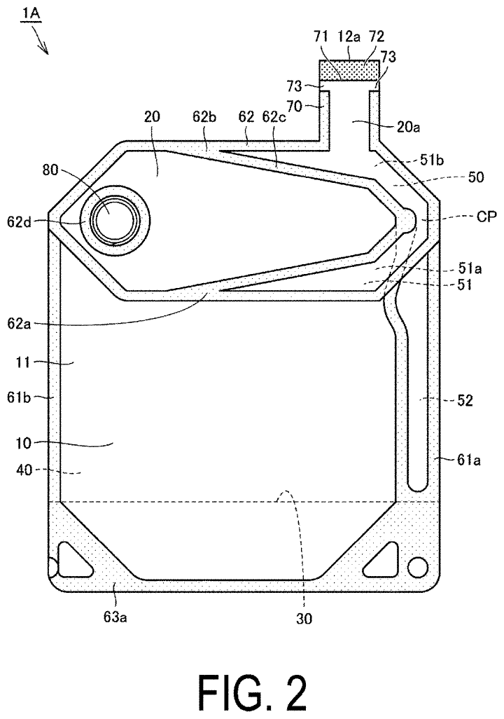

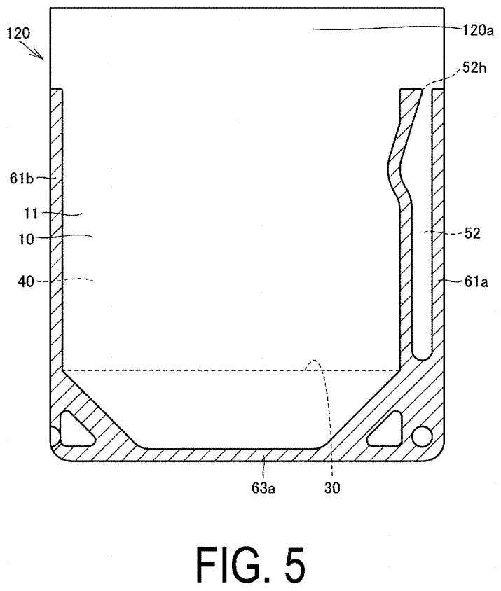

FIG. 1 is a perspective view illustrating an external shape of a pouch container according to a first embodiment, and FIG. 2 is a front view of the pouch container illustrated in FIG. 1 in a folded state. First, with reference to FIGS. 1 and 2, a configuration of a pouch container 1A according to the present embodiment will be described. Note that for ease of understanding, seal portions of film members having a sheet-like shape that form the pouch container 1A, are lightly colored in FIGS. 1 and 2 (the same applies to FIGS. 5, 6, 8, and 10 to 18, which will be described later).

As illustrated in FIGS. 1 and 2, the pouch container 1A mainly includes a body section 10, a top gusset section 20, and a bottom gusset section 30. The pouch container 1A is provided therein with a storage space 40 in which contents are stored, and a gas filling space 50 that is a space different from the storage space 40.

The body section 10 is formed by a pair of body-section-forming film members having a sheet-like shape facing each other. One of the pair of body-section-forming film members forms a front wall section 11 and another of the pair of body-section-forming film members forms a rear wall section 12. The body section 10 is formed by overlapping and joining both edge portions of both the front wall section 11 and the rear wall section 12 in a width direction. As a result, a pair of a first body-section-side seal portion 61a and a second body-section-side seal portion 61b are formed at both edge portions of the body section 10 in a width direction.

Here, in the present embodiment, a first wall section of a pair of wall sections forming a gas injection portion 70 (described later) with a portion thereof corresponds to the top gusset section 20 described above, and a second wall section of the pair of wall sections corresponds to the rear wall section 12 of the body section 10 described above.

The top gusset section 20 is formed by overlapping and joining an edge portion of a top-gusset-section-forming film member having a sheet-like shape to an edge portion of the front wall section 11 and an edge portion of the rear wall section 12, respectively, which form one end of the body section 10 in an axis direction. As a result, a top-gusset-section-side seal portion 62 is formed at a peripheral edge of the top gusset section 20 and the body section 10 at portions corresponding thereto.

The top-gusset-section-side seal portion 62 includes a first top-gusset-section-side seal portion 62a formed at a boundary between the front wall section 11 of the body section 10 and the top gusset section 20, and a second top-gusset-section-side seal portion 62b formed at a boundary between the rear wall section 12 of the body section 10 and the top gusset section 20. The top-gusset-section-side seal portion 62 further includes a third top-gusset-section-side seal portion 62c formed so as to traverse the top gusset section 20 in a substantially V-shape when viewed in a plan view by joining the top-gusset-section-forming film member to the pair of body-section-forming film members.

The top gusset section 20 is further provided with a spout 80 formed of a cylindrical member having a male thread formed on an outer peripheral surface thereof, which is joined to the top gusset section 20 so as to plug a hole portion provided in the top gusset section 20. As a result, a spout seal portion 62d is positioned so as to surround the hole portion provided in the top gusset section 20, and a joint between the top gusset section 20 and the spout 80 is formed by the spout seal portion 62d. Note that a cap (not illustrated) is removably attached to the spout 80.

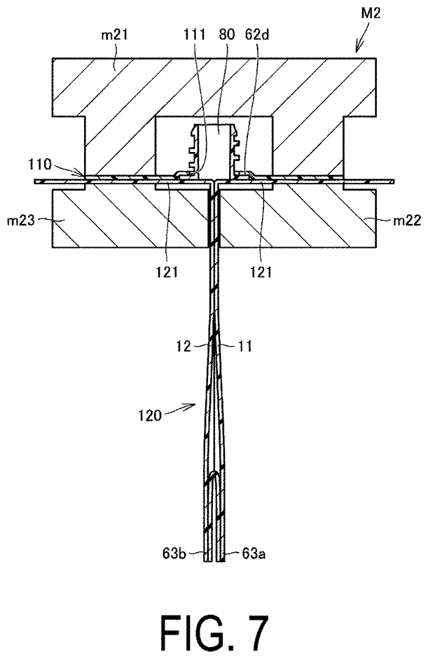

The bottom gusset section 30 is formed by overlapping and joining an edge portion of a bottom-gusset-section-forming film member having a sheet-like shape to an edge portion of the front wall section 11 and an edge portion of the rear wall section 12, respectively, which form the other end of the body section 10 in the axis direction. As a result, a first bottom-gusset-section-side seal portion 63a is formed at the boundary between the front wall section 11 of the body section 10 and the bottom gusset section 30, and a second bottom-gusset-section-side seal portion 63b (see FIG. 7) is formed at a boundary between the rear wall section 12 of the body section 10 and the bottom gusset section 30.

The storage space 40 is defined by the body section 10, the top gusset section 20, and the bottom gusset section 30, and the storage space 40 is hermetically sealed with respect to the outside by the first body-section-side seal portion 61a and the second body-section-side seal portion 61b, the first top-gusset-section-side seal portion 62a, the second top-gusset-section-side seal portion 62b and the third top-gusset-section-side seal portion 62c, and the first bottom-gusset-section-side seal portion 63a and the second bottom-gusset-section-side seal portion 63b.

Here, the body-section-forming film member forming the body section 10, the top-gusset-section-forming film member forming the top gusset section 20, and the bottom-gusset-section-forming film member forming the bottom gusset section 30 are made of, for example, a resin film member. The resin film member is preferably a laminate of a base film layer that provides basic performance (impact resistance, abrasion resistance, heat resistance, etc.) as a package, and a sealant layer that enables joining. In some cases, in addition to the base film layer and the sealant layer, the resin film member may be composed of a laminate having a barrier layer between the base film layer and the sealant layer, the barrier layer providing additional performance such as high gas barrier properties and light shielding properties.

Examples of the material for the base film layer include polyester represented by polyethylene terephthalate, polyethylene naphthalate, polybutylene terephthalate, and polycarbonate, polyolefin represented by polyethylene and polypropylene, polyamide represented by nylon 6 and nylon 66, polyacrylonitrile, polyimide, polyvinyl chloride, polyvinylidene chloride, polymethyl methacrylate, and polyethersulfone.

Examples of the material for the sealant layer include low-density polyethylene, linear low-density polyethylene, ethylene-propylene copolymer, cast polypropylene, oriented nylon, ethylene-olefin copolymer, ethylene-acrylic acid copolymer, ethylene-methacrylic acid copolymer, and ethylene-vinyl acetate copolymer.

Examples of the material for the barrier layer include metal represented by aluminum, resin represented by vinylidene chloride and ethylene-vinyl alcohol copolymer, aluminum oxide, and silica.

Examples of the method of sealing the film members described above include fusion by heat sealing, ultrasonic sealing, and high-frequency sealing, and adhesion by an adhesive.

The pouch container 1A is further provided with the gas filling space 50 that is a space different from the storage space 40. The gas filling space 50 includes a first space 51 located between the body section 10 and the top gusset section 20 by being surrounded by the first top-gusset-section-side seal portion 62a, the second top-gusset-section-side seal portion 62b, and the third top-gusset-section-side seal portion 62c, and a second space 52 located between the front wall section 11 and the rear wall section 12 by being surrounded by the first body-section-side seal portion 61a.

The first space 51 includes a front-wall-section-side first space 51a and a rear-wall-section-side first space 51b that are further branched into two as illustrated in FIG. 2, due to the V-shaped configuration of the third top-gusset-section-side seal portion 62c surrounding the first space 51 in a plan view.

The second space 52 extends in the axis direction of the body section 10, and communicates with the first space 51 at an end portion of the first body-section-side seal portion 61a on the top gusset section 20 side (see a coupling position CP in FIGS. 1 and 2). That is, the gas filling space 50 constituted by the first space 51 and the second space 52 forms a single space.

By sealing gas in the gas filling space 50 including the front-wall-section-side first space 51a, the rear-wall-section-side first space 51b, and the second space 52, deformation of the top gusset section 20 can be suppressed and the like, and the details thereof will be described later.

Note that, the gas to be sealed in the gas filling space is not limited to any particular gas, and, for example, air, nitrogen, oxygen, or an inert gas such as argon or helium can be used. In particular, when air is used, the manufacturing cost of the pouch container 1A can be made more inexpensive.

Here, the top gusset section 20 as the first wall section includes a first tongue-shaped portion 20a that projects outward from an edge portion of the top gusset section 20 at a portion where the second top-gusset-section-side seal portion 62b is formed. On the other hand, the rear wall section 12 as the second wall section includes a second tongue-shaped portion 12a that projects outward from the edge portion of the rear wall section 12 at a portion where the second top-gusset-section-side seal portion 62b is formed and overlaps the first tongue-shaped portion 20a. Note that a projection length of the second tongue-shaped portion 12a is formed so as to be longer than a projection length of the first tongue-shaped portion 20a.

By joining both end portions of both the first tongue-shaped portion 20a and the second tongue-shaped portion 12a that overlap with each other in a width direction, the edge portion of the top gusset section 20 and the edge portion of the rear wall section 12 at a portion where the second top-gusset-section-side seal portion 62b is formed are provided with the gas injection portion 70 having a projection shape formed by the first tongue-shaped portion 20a and the second tongue-shaped portion 12a.

The gas injection portion 70 is for injecting gas into the gas filling space 50 therethrough. The gas injection portion 70 is formed with an injection port 71 that communicates with the rear-wall-section-side first space 51b. The injection port 71 is defined by a tip end portion of the first tongue-shaped portion 20a in a projection direction and the second tongue-shaped portion 12a at a portion facing the tip end portion. Gas is filled in the gas filling space 50 by injecting gas from a gas injection device with a nozzle or the like of the gas injection device inserted into the injection port 71.

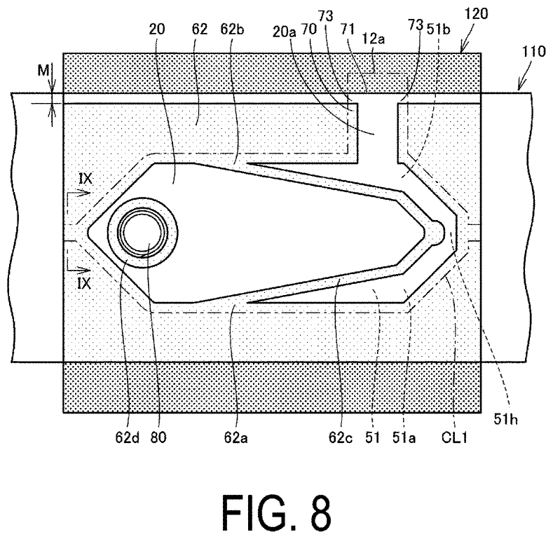

Here, as described above, the projection length of the second tongue-shaped portion 12a is formed to be longer than the projection length of the first tongue-shaped portion 20a. Thus, only the second tongue-shaped portion 12a is located at a tip end portion of the gas injection portion 70 and the first tongue-shaped portion 20a is not. By configuring the gas injection portion 70 in this manner, a guide portion 72 formed by the tip end portion of the second tongue-shaped portion 12a is positioned at the tip end portion of the gas injection portion 70. The guide portion 72 will be described in detail later. Note that, for ease of understanding, the guide portion 72 is dark in FIGS. 1 and 2, (the same applies to FIGS. 8 and 10 to 18, which will be described later).

In addition, both end portions of both the first tongue-shaped portion 20a and the second tongue-shaped portion 12a in the width direction are joined only at root-side portions of the gas injection portion 70, and at the tip-end-side portions of the gas injection portion 70, non-joined portions 73 are provided without joining the first tongue-shaped portion 20a and the second tongue-shaped portion 12a. The non-joined portions 73 will also be described in detail later.

Note that after gas is injected into the gas filling space 50 through the gas injection portion 70, the gas injection portion 70 is sealed at the root portion thereof. This completes the sealing of gas in the gas filling space 50. The gas injection portion 70 may be cut off from the pouch container 1A after the gas is sealed in the gas filling space 50.

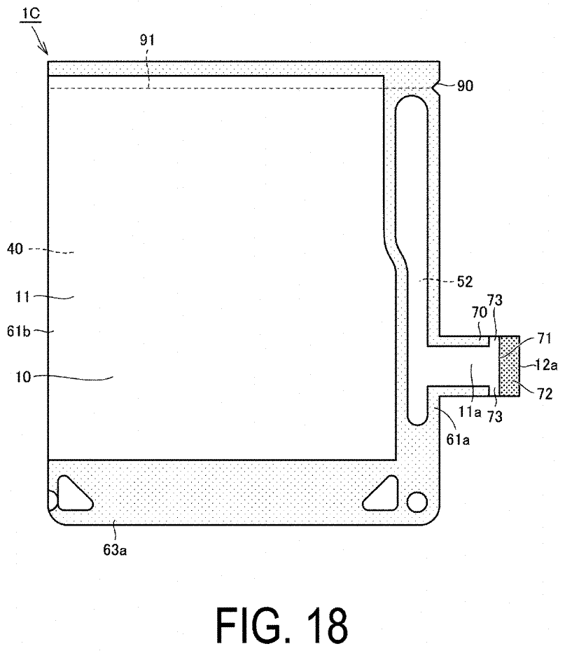

The body section 10 of the pouch container 1A does not necessarily have to be made according to the method using the pair of film members having the sheet-like shape described above, but may be made according to any other method. For example, as in a pouch container 1C (see FIG. 18) according to a third embodiment, which will be described later, the body section 10 may be made according to a method of folding and then sealing a single film member having a sheet-like shape.

Further, the pouch container 1A does not necessarily include the top gusset section 20 or the bottom gusset section 30. When the pouch container 1A does not include the top gusset section 20 or the bottom gusset section 30, the front wall section 11 and the rear wall section 12 may be overlapped and joined at both end portions thereof in the axis direction of the body section 10 so as to form seal portions at both end portions. In this case, the gas injection portion 70 may be provided projecting from the seal portion located at the end portion in the axis direction of the body section 10, or may be provided projecting from the seal portion formed in the width direction of the body section 10.

Note that, in the present embodiment, the pouch container in which the gas injection portion 70 is provided at the portion where the top gusset section 20 as the first wall section and the rear wall section 12 as the second wall section are overlapped and sealed is described, but the combination of the first wall section and the second wall section is not limited to the above-described combination. For example, the first wall section may be the top gusset section 20 and the second wall section may be the front wall section 11, or the first wall section may be either the front wall section 11 or the rear wall section 12 and the second wall section may be the top gusset section 20. Further, one of the first wall section and the second wall section may be the front wall section 11 and another may be the rear wall section 12, or one of the first wall section and the second wall section may be one of the front wall section 11 and the rear wall section 12 and another may be the bottom gusset section 30.

That is, the position where the gas injection portion 70 is provided is not limited to the portion where the top gusset section 20 and the body section 10 are overlapped and sealed, but may be a portion where the front wall section 11 and the rear wall section 12 that form the body section 10 are overlapped and sealed at the end portion of the body section 10 in the width direction, or a portion where the bottom gusset section 30 and the body section 10 are overlapped and sealed.

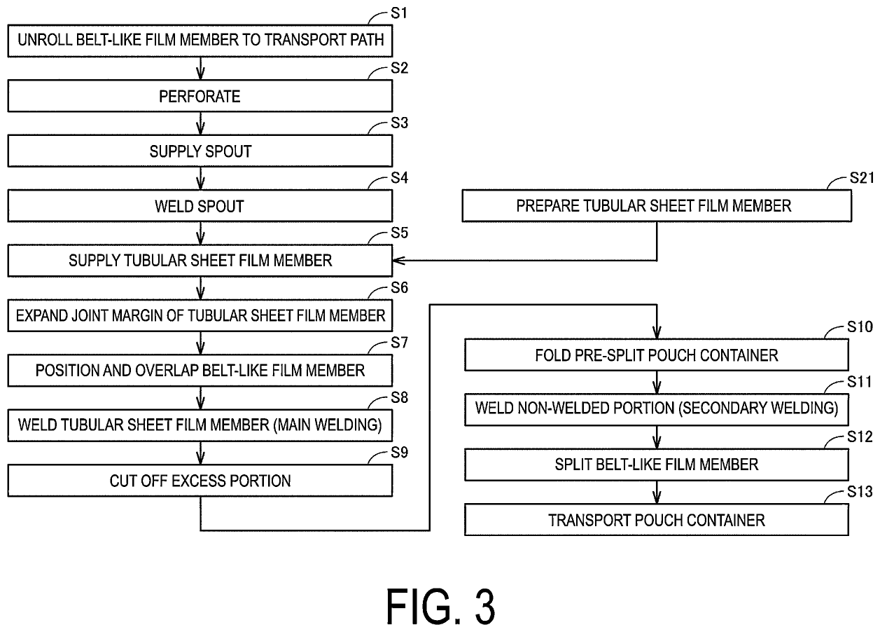

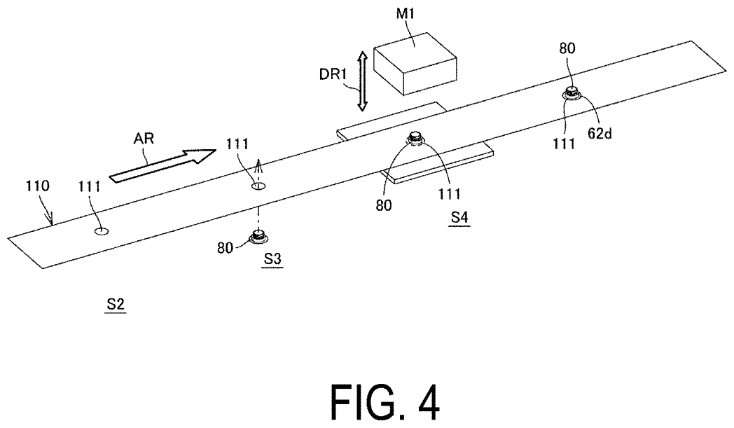

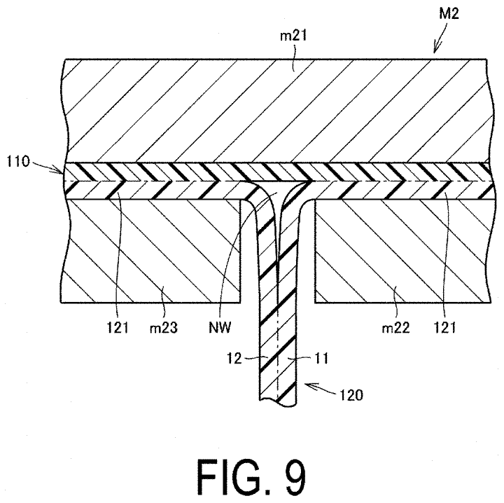

FIG. 3 is a diagram showing a manufacturing flow according to a method of manufacturing the pouch container according to the first embodiment. FIGS. 4, 6, 10, and 13 are schematic perspective views for describing the method of manufacturing the pouch container according to the present embodiment, and FIG. 5 is a front view of a tubular sheet film member as a material for the pouch container according to the present embodiment. FIGS. 7 and 9 are schematic cross-sectional views for describing the method of manufacturing the pouch container according to the present embodiment, and FIGS. 8, 11, and 12 are schematic plan views for describing the method of manufacturing the pouch container according to the present embodiment. Next, the method of manufacturing the pouch container according to the present embodiment will be described with reference to FIGS. 3 to 13.

As illustrated in FIG. 3, the method of manufacturing the pouch container according to the present embodiment is a method for continuously manufacturing a plurality of pouch containers 1A (see FIGS. 1, 2, and 13), each of which is provided therein with the storage space 40 for storing contents and the gas filling space 50 that is the space different from the storage space 40, using a single belt-like film member 110 (see FIG. 4, etc.) including a plurality of portions to be the top gusset sections 20 of the pouch container 1A described above, and the plurality of tubular sheet film members 120 (see FIG. 5, etc.), each of which includes a portion to be the body section 10 of the pouch container 1A described above as materials, in which a plurality of tubular sheet film members 120 are supplied sequentially onto the single belt-like film member 110 and joined to the single belt-like film member 110.

In the method of manufacturing the pouch container according to the present embodiment, before the belt-like film member 110 and the tubular sheet film member 120 supplied thereto are joined together, the belt-like film member 110 in a transported state is subjected to predetermined processing and the tubular sheet film member 120 in a transported state is subjected to predetermined processing. Further, in the method of manufacturing the pouch container according to the present embodiment, also after the belt-like film member 110 and the tubular sheet film member 120 supplied thereto are joined together, the belt-like film member 110 and the tubular sheet film member 120 supplied thereto are subjected to predetermined processing.

Thus, by following the method of manufacturing the pouch container according to the present embodiment, the plurality of pouch containers 1A described above can be continuously manufactured in large quantities.

First, as illustrated in FIG. 3, in step S1, the belt-like film member 110 (see FIG. 4, etc.) is unrolled into a transport path along a longitudinal direction of the belt-like film member 110.

Subsequently, as illustrated in FIGS. 3 and 4, in step S2, the belt-like film member 110 is perforated. The perforation is performed by a perforation mechanism (not illustrated), whereby the belt-like film member 110 is provided with a spout hole 111, which is substantially circular in a plan view. Note that arrow AR illustrated in FIG. 4 indicates a transport direction of the belt-like film member 110.

Subsequently, as illustrated in FIGS. 3 and 4, in step S3, the spout 80 is supplied to the belt-like film member 110, and in step S4, the spout 80 is welded to the belt-like film member 110.

More specifically, after the spout 80 supplied to the belt-like film member 110 is inserted into the spout hole 111 provided in the belt-like film member 110, a flange-shaped portion of the spout 80 and the belt-like film member 110 at a portion to which the flange-shaped portion is attached are heated and pressed by a descending first welding jig M1, which is configured to be driven in an axis direction of the tubular sheet film member 120 (i.e., a direction of arrow DR1 illustrated in FIG. 4), thereby welding the spout 80 to the belt-like film member 110 via the spout seal portion 62d.

After this step, the spout seal portion 62d may be cooled. This improves the joining strength of the spout seal portion 62d and lowers the temperature of the spout seal portion 62d to about room temperature, allowing a rapid transition to a next step.

Through the several kinds of processing in steps S2 to S4 described above, the spout 80 is attached to the belt-like film member 110 via the spout seal portion 62d. Here, the portion of the belt-like film member 110 to which the spout 80 is attached is a portion to be the top gusset section of the belt-like film member 110.

Note that the attachment of the spout 80 to the belt-like film member 110 is not limited to the method described above. For example, the spout 80 may be attached to the belt-like film member 110 by being welded to a surface of the belt-like film member 110 in which the spout hole 111 is not provided. In this case, the spout hole 111 may be formed when the pouch container 1A is used, and this configuration can improve the barrier properties for the contents.

On the other hand, as illustrated in FIGS. 3 and 5, in step S21, the plurality of tubular sheet film members 120 are prepared.

The preparation of the plurality of tubular sheet film members 120 is performed on a transport path different from the transport path on which the belt-like film member 110 is being transported, and each of the plurality of tubular sheet film members 120 prepared in this step is configured to include the body section 10 and the bottom gusset section 30.

More specifically, first, both edge portions of the pair of body-section-forming film members having the sheet-like shape facing each other in the width direction are overlapped, and portions of the edge portions other than a pair of end portions in the axis direction are joined to form the body section 10 having the front wall section 11 and the rear wall section 12 included in the tubular sheet film member 120. This forms the pair of the first body-section-side seal portion 61a and the second body-section-side seal portion 61b at the edge portions of the body section 10 in the width direction, and open ends at the pair of end portions of the body section 10 in the axis direction.

Here, the second space 52 of the gas filling space 50 is formed in the body section 10 so as to be surrounded by the first body-section-side seal portion 61a. As a result, the second space 52 is located between the front wall section 11 and the rear wall section 12.

Subsequently, the edge portion of the bottom-gusset-section-forming film member having the sheet-like shape is overlapped and joined to both of the edge portion of the front wall section 11 and the edge portion of the rear wall section 12, which constitute one of the pair of open ends formed in the body section 10, so as to form the bottom gusset section 30 included in the tubular sheet film member 120. This forms the first bottom-gusset-section-side seal portion 63a at the boundary between the front wall section 11 and the bottom gusset section 30, and the second bottom-gusset-section-side seal portion 63b at the boundary between the rear wall section 12 and the bottom gusset section 30 (see FIG. 7).

At one end of the tubular sheet film member 120 configured in this manner, on the side in which the bottom gusset section 30 in the axis direction is not formed, a top-gusset-section-side open end 120a, which will form a top gusset section of the pouch container 1A in a subsequent step, is formed. Further, an opening 52h that communicates with the second space 52 is provided at an end portion of the first body-section-side seal portion 61a on the side of the top-gusset-section-side open end 120a.

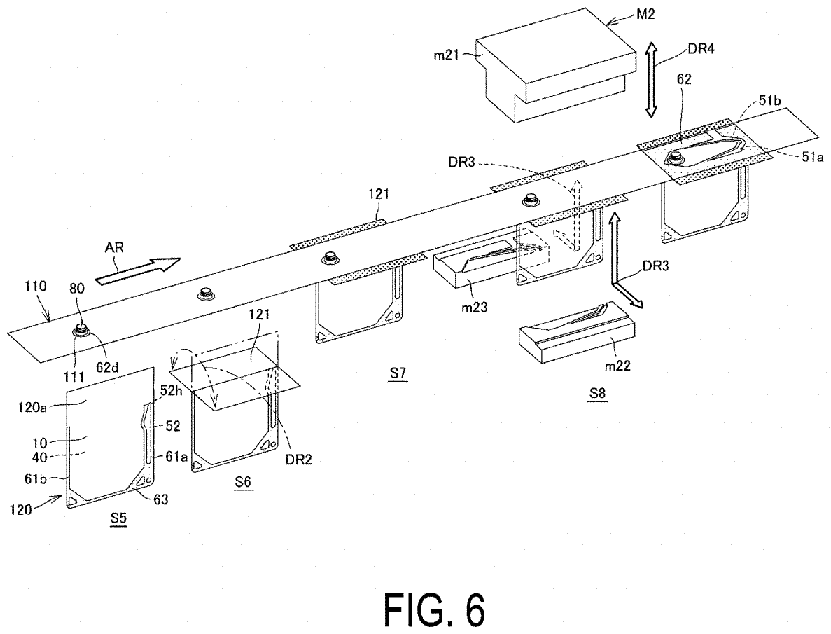

Subsequently, as illustrated in FIGS. 3 and 6, in step S5, the tubular sheet film member 120 is supplied to the belt-like film member 110, and in step S6, a joint margin 121 of the tubular sheet film member 120 is expanded.

More specifically, the front wall section 11 and the rear wall section 12 at portions constituting the top-gusset-section-side open end 120a are individually held by suction using a vacuum head or the like (not illustrated) and are pulled away from each other, so that the joint margin 121 provided at the top-gusset-section-side open end 120a is in an expanded state. As a result, the joint margin 121 is expanded (see arrow DR2 illustrated in FIG. 6).

Subsequently, as illustrated in FIGS. 3 and 6, in step S7, the tubular sheet film member 120 supplied to the belt-like film member 110 is positioned and superimposed on the belt-like film member 110. More specifically, the tubular sheet film member 120 is supplied such that the joint margin 121 of the tubular sheet film member 120 overlaps a portion to be the top gusset section of the belt-like film member 110.

Here, when the joint margin 121 is superimposed on the portion to be the top gusset section of the belt-like film member 110, the edge portion of the joint margin 121, which will form the second tongue-shaped portion 12a through the excision of the excess portion in step S9, which is a subsequent step, is positioned so as to be located outside the edge portion of the portion to be the top gusset section of the belt-like film member 110, which will form the first tongue-shaped portion 20a through the excision. This configuration will provide the guide portion 72 at the tip end portion of the gas injection portion 70 in the projection direction formed through the excision described above, and the details thereof will be described later.

By being positioned as described above, the edge portion of the joint margin 121 is provided with a portion not overlapped with the belt-like film member 110. Note that, for ease of understanding, the relevant portion is colored dark in FIG. 6 (the same is applied to FIGS. 8, 10, and 11 described later).

Subsequently, as illustrated in FIGS. 3 and 6 to 9, in step S8, the tubular sheet film member 120 is welded to the belt-like film member 110. Note that FIG. 7 is a schematic cross-sectional view of the spout 80 and the vicinity thereof orthogonal to the transport direction of the belt-like film member 110 in a state in which the belt-like film member 110 and the tubular sheet film member 120 are sandwiched by a second welding jig M2 described later, and FIG. 8 is a schematic plan view of the belt-like film member 110 and the tubular sheet film member 120 after welding. FIG. 9 is a schematic enlarged cross-sectional view of a key part taken along line IX-IX in FIG. 8.

More specifically, the belt-like film member 110 and the joint margin 121 of the tubular sheet film member 120 are welded by the heated second welding jig M2. The second welding jig M2 includes a first mold m21 disposed above the belt-like film member 110, and a pair of a second mold m22 and a third mold m23, which are half-split molds, disposed below the joint margin 121 and facing each other so as to sandwich the tubular sheet film member 120 therebetween.

The first mold m21 is configured to be driven in the axis direction of the tubular sheet film member 120, and the second mold m22 and the third mold m23 are configured to be driven not only in the axis direction but also in a direction approaching or away from the tubular sheet film member 120 on a plane orthogonal to the axis direction (see arrow DR3 and arrow DR4 illustrated in FIG. 6). The first mold m21, the second mold m22, and the third mold m23 are driven by actuators or the like (not illustrated).

Further, protruding portions are provided on a lower surface of the first mold m21 and upper surfaces of the second mold m22 and the third mold m23, respectively. These protruding portions have shapes corresponding to the first top-gusset-section-side seal portion 62a, the second top-gusset-section-side seal portion 62b, and the third top-gusset-section-side seal portion 62c, which are formed at the portions in which the joint margin 121 and the belt-like film member 110 are overlapped, which will be described later.

When the belt-like film member 110 and the joint margin 121 of the tubular sheet film member 120 are welded together, first, the protruding portions provided on the upper surfaces of the second mold m22 and the third mold m23, respectively, are driven so as to come into contact with the lower surface of the joint margin 121.

Subsequently, the first mold m21 is lowered toward the belt-like film member 110 such that the protruding portion provided thereon comes into contact with the belt-like film member 110. As a result, as illustrated in FIG. 7, the joint margin 121 of the tubular sheet film member 120 is superimposed on the belt-like film member 110 at the portion where the spout 80 is attached (i.e., the portion to be the top gusset section), and these are sandwiched by the protruding portions provided on the first mold m21, the second mold m22, and the third mold m23.

At this time, by sandwiching the joint margin 121 and the belt-like film member 110, which are overlapped together, by the first mold m21, the second mold m22, and the third mold m23, which are heated, as illustrated in FIG. 8, the edge portion of the joint margin 121 and the edge portion of the portion to be the top gusset section of the belt-like film member 110, which are overlapped, are welded together via the top-gusset-section-side seal portion 62 including the first top-gusset-section-side seal portion 62a, the second top-gusset-section-side seal portion 62b, and the third top-gusset-section-side seal portion 62c. As a result, the top-gusset-section-side open end 120a of the tubular sheet film member 120 is closed by the portion to be the top gusset section of the belt-like film member 110.

Further, a branch position of the front-wall-section-side first space 51a and the rear-wall-section-side first space 51b described above corresponds to the boundary portion of the front wall section 11 side and the rear wall section 12 side of the joint margin 121, and an opening 51h opened toward the body section 10 side is provided at the branch position.

At that time, by forming the opening 51h so as to overlap the opening 52h (see FIG. 5) provided in the tubular sheet film member 120 when the tubular sheet film member 120 is prepared, the second space 52 is communicated with the first space 51 at the end portion of the first body-section-side seal portion 61a on the side of the top-gusset-section-side open end 120a. Thus, the gas filling space 50 including the first space 51 and the second space 52 has a single space.

Further, an area in which the top-gusset-section-side seal portion 62 is formed is disposed so as to be located inside the outer edge of the belt-like film member 110 in the width direction, which is the side in which the gas injection portion 70 is provided (i.e., disposed so that a margin M illustrated in FIG. 8 is provided). With this configuration, in step S9, which is a subsequent step, both end portions of both the first tongue-shaped portion 20a and the second tongue-shaped portion 12a in the width direction formed by cutting off the excess portions are joined only at the root-side portions of the gas injection portion 70, and a non-joined portion 73 is provided at the tip-end-side portion of the gas injection portion 70.

Here, by providing the non-joined portion 73, the welding of the belt-like film member 110 and the joint margin 121 is performed by the heated second welding jig M2 at a position spaced apart from the edge portion of the joint margin 121 that is not superimposed on the belt-like film member 110 (i.e., the dark-colored portion in FIG. 8). This effectively prevents a sealant layer provided on a surface of the edge portion of the joint margin 121 at the portion that is not superimposed on the belt-like film member 110 from being melted by the heat of the second welding jig M2 and adhering to the second welding jig M2.

Further, after the top-gusset-section-side open end 120a of the tubular sheet film member 120 is closed by the portion to be the top gusset section of the belt-like film member 110 as described above, the top-gusset-section-side seal portion 62 may be cooled. This improves the joining strength of the top-gusset-section-side seal portion 62, and lowers the temperature of the top-gusset-section-side seal portion 62 to about room temperature, allowing a rapid transition to a next step.

As illustrated in FIG. 9, in a state in which the first top-gusset-section-side seal portion 62a, the second top-gusset-section-side seal portion 62b, and the third top-gusset-section-side seal portion 62c are formed in step S8, a non-welded portion NW exists at a boundary portion between the belt-like film member 110, the joint margin 121 on the front wall section 11 side and the rear wall section 12 side, the front wall section 11, and the rear wall section 12.

The non-welded portion NW is a portion of the top-gusset-section-side seal portion 62 formed by welding the joint margin 121 of the tubular sheet film member 120 and the portion to be the top gusset section of the belt-like film member 110 in step S8 described above, where the welding has not been completed yet, and the non-welded portion NW is located at a position corresponding to a boundary portion of the pair of the second mold m22 and third mold m23, which are half-split molds, described above in the top-gusset-section-side seal portion 62.

When the non-welded portion NW remains in the pouch container 1A as a product, there is a concern that the contents may leak out therefrom. In order to prevent this, the non-welded portion NW is welded in step S11, which is a subsequent step, and the details thereof are described later.

Through the processes in steps S5 to S8 described above, the tubular sheet film member 120 is joined to the portion to be the top gusset section of the belt-like film member 110.

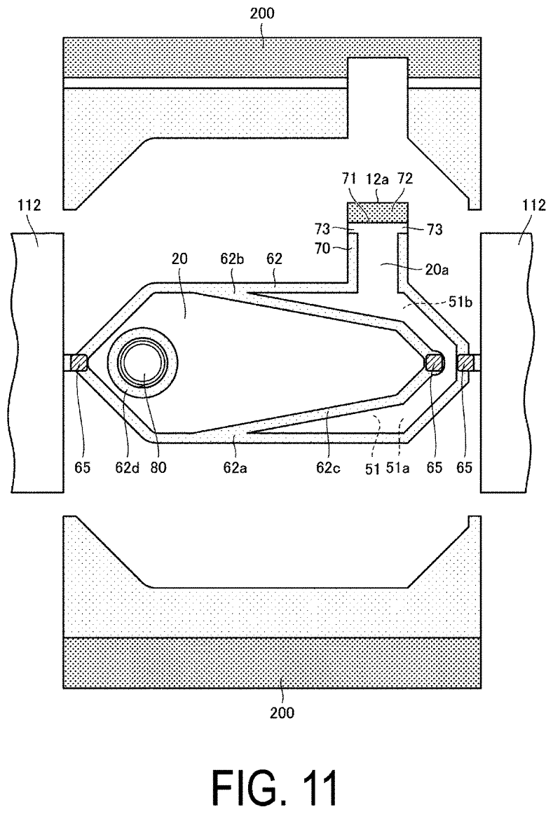

Subsequently, as illustrated in FIGS. 3, 10, and 11, excess portions 200 are cut off in step S9. More specifically, the body section 10 and the top gusset section 20 of the pouch container 1A are formed by cutting off the excess portions 200 from the joint margin 121 and the portion to be the top gusset section of the belt-like film member 110. Note that FIG. 11 is a schematic plan view of the belt-like film member 110 and the tubular sheet film member 120 after the excess portions 200 are cut off in step S9.

Here, as illustrated in FIG. 11, the excess portions 200 are portions located in the width direction of the belt-like film member 110 in an area surrounding the joint margin 121 and the portion to be the top gusset section of the belt-like film member 110. The excess portions 200 are cut off by cutting the joint margin 121 and the belt-like film member 110 along a cut line CL1 (see FIG. 8) by a cutting mechanism.

Note that the cut line CL1 described above is marked with an alternate long and short dash line as a virtual line for indicating the boundary between the cut portion and the non-cut portion of the belt-like film member 110 and the tubular sheet film member 120 in a plan view before cutting.

Further, by cutting off the excess portions 200, coupling portions 112 are formed in portions located in the longitudinal direction of the belt-like film member 110 in the area surrounding the portion to be the top gusset section of the belt-like film member 110. The coupling portion 112 couples the pre-split pouch containers, each of which is formed of the tubular sheet film member 120 and the belt-like film member 110 at the portion to which the tubular sheet film member 120 is welded, along the longitudinal direction of the belt-like film member 110.

Further, by cutting off the excess portions 200, the first tongue-shaped portion 20a projecting outward from the edge portion is formed at the edge portion of the top gusset section 20, and the second tongue-shaped portion 12a overlapping the first tongue-shaped portion 20a by projecting outward from the edge portion is formed at the edge portion of the body section 10.

The first tongue-shaped portion 20a and the second tongue-shaped portion 12a formed overlapping each other in this manner are joined at both end portions thereof in the width direction as described above. With this configuration, at the edge portion of the body section 10 and the edge portion of the top gusset section 20 at the portion where the second top-gusset-section-side seal portion 62b is formed, the gas injection portion 70, in which the injection port 71 communicating with the gas filling space 50 is formed, is provided.

Here, as described above, when the joint margin 121 is superimposed on the portion to be the top gusset section of the belt-like film member 110 in step S7, the edge portion of the joint margin 121 is positioned outside the edge portion of the portion to be the top gusset section of the belt-like film member 110. With this configuration, the injection port 71 formed by cutting off the excess portions 200 is defined by the tip end portion of the first tongue-shaped portion 20a in the projection direction and the second tongue-shaped portion 12a at the portion facing the tip end portion.

Further, since the projection length of the second tongue-shaped portion 12a formed here is formed so as to be longer than the projection length of the first tongue-shaped portion 20a, at the tip end portion of the gas injection portion 70, only the second tongue-shaped portion 12a is located and the first tongue-shaped portion 20a is not. As a result, the tip end portion of the gas injection portion 70 is provided with the guide portion 72 formed by the tip end portion of the second tongue-shaped portion 12a.

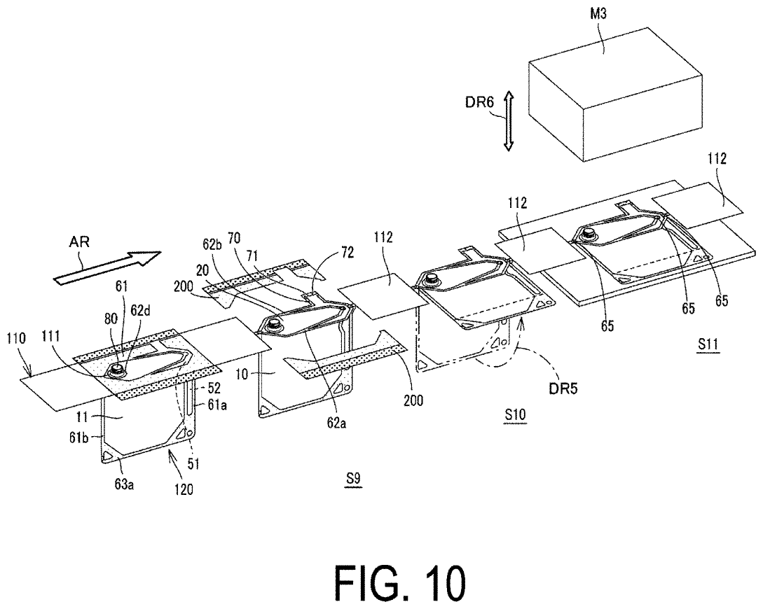

Subsequently, as illustrated in FIGS. 3 and 10, in step S10, the pre-split pouch container is folded. More specifically, portions of the tubular sheet film member 120, which is a part of the pre-split pouch container, other than the joint margin 121 are folded by a folding mechanism not illustrated in the figure (see arrow DR5 illustrated in FIG. 10). As a result, the portions other than the joint margin 121 are disposed parallel to the joint margin 121.

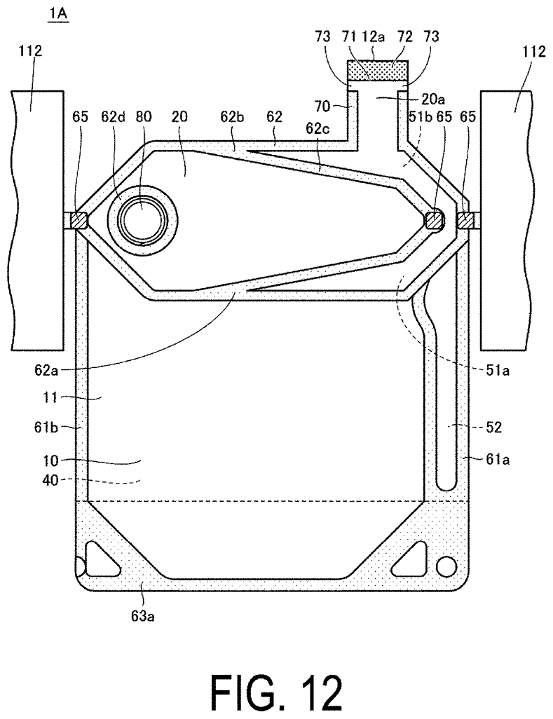

Subsequently, as illustrated in FIGS. 3, 10, and 12, in step S11, the non-welded portion NW is welded. Here, the non-welded portion NW is the portion of the top-gusset-section-side seal portion 62 formed in step S8 described above that is not yet completely welded (see FIG. 9). Note that FIG. 12 is a schematic plan view of a pre-split pouch container after secondary welding in step S11.

More specifically, the non-welded portions NW of the pre-split pouch container are heated, and pressed by a descending third welding jig M3 configured to be driven in a direction orthogonal to the plane including the pre-split pouch container (i.e., a direction of arrow DR6 illustrated in FIG. 10). As a result, a plurality of auxiliary seal portions 65 are formed in the non-welded portions NW as illustrated in FIG. 12.

After this step, the auxiliary seal portions 65 may be cooled. This improves the joining strength of the auxiliary seal portions 65 and lowers the temperature of the auxiliary seal portions 65 to about room temperature, allowing rapid transition to a next step.

Through the processing in step S11 described above, the non-welded portion NW no longer exists, and the tubular sheet film member 120 is completely joined to the portion to be the top gusset section of the belt-like film member 110.

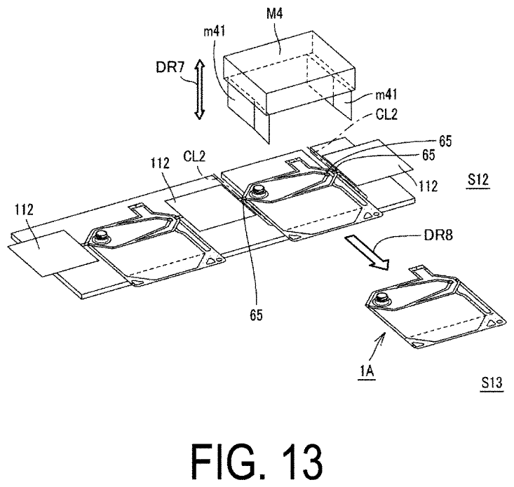

Subsequently, as illustrated in FIGS. 3 and 13, in step S12, the belt-like film member 110 is split.

More specifically, the pre-split pouch container is split along cut lines CL2 (see FIG. 13) by lowering a cutting jig M4 having a pair of cutting blades m41 and configured to be driven in a direction orthogonal to the plane including the pre-split pouch container (i.e., a direction of arrow DR7 illustrated in FIG. 13). The cut lines CL2 are marked with alternate long and short dash lines as virtual lines for indicating split positions of the pre-split pouch container, and are positioned so as to vertically travel across two of the plurality of auxiliary seal portions 65 adjacent to the coupling portions 112. With this configuration, one pouch container 1A is cut out from the pre-split pouch container.

Subsequently, as illustrated in FIGS. 3 and 13, in step S13, the pouch container 1A is transported in a direction of arrow DR8 illustrated in FIG. 13. This completes the manufacture of the pouch container 1A illustrated in FIG. 1.

In the pouch container 1A according to the present embodiment described above, in the gas injection portion 70 for injecting gas into the gas filling space 50, the injection port 71 communicating with the gas filling space 50 is formed, and the guide portion 72 formed by the tip end portion of the second tongue-shaped portion 12a is provided at the tip end portion of the gas injection portion 70.

With this configuration, when inserting the nozzle or the like of the gas injection device into the injection port 71, the guide portion 72 functions as a guide for inserting the nozzle or the like, so that the nozzle or the like can be smoothly inserted. This facilitates gas injection and facilitates the manufacture of a pouch container with a gas filling space therein.

Further, manufacture of the guide portion 72 does not require an additional punch unit or the like, and does not require high processing accuracy. This not only reduces the manufacturing cost of the pouch container 1A, but also simplifies the manufacturing process compared with a known manufacturing process. This facilitates gas injection and facilitates the manufacture of a pouch container with a gas filling space therein.

Thus, by adopting the pouch container 1A and the method of manufacturing the pouch container 1A according to the present embodiment, it is possible to facilitate gas injection and facilitate manufacture of a pouch container with a gas filling space therein.

In the pouch container 1A according to the present embodiment, as described above, both end portions of both the first tongue-shaped portion 20a and the second tongue-shaped portion 12a in the width direction are joined only at the root-side portions of the gas injection portion 70, and the non-joined portion 73 is located at the tip-end-side portion of the gas injection portion 70.

With this configuration, when inserting the nozzle or the like into the injection port 71, the nozzle or the like spreads the gas injection portion 70 to open the injection port 71 more widely, so that the insertion of the nozzle or the like can be performed more smoothly. This facilitates gas injection and facilitates the manufacture of a pouch container with a gas filling space therein.

In the pouch container 1A according to the present embodiment, as described above, the gas filling space 50 includes the front-wall-section-side first space 51a and the rear-wall-section-side first space 51b that are branched into two. This configuration effectively suppresses the occurrence of deformation of the top gusset section 20 when the contents are poured out from the spout 80 or when the pouch container 1A is transported.

In the pouch container 1A according to the present embodiment, the gas filling space 50 further includes the second space 52 extending in the axis direction of the body section 10. This configuration not only makes the pouch container 1A more self-supporting, but also allows the second space 52 to function as a gripping portion, thereby facilitating the handling of the pouch container 1A.

Further, in the pouch container 1A according to the present embodiment, the first space 51 provided adjacent to the gas injection portion 70 communicates with the second space 52, thereby providing the gas filling space 50 as a single space over a wider range of the pouch container 1A. This configuration allows the gas injection portion 70 for injecting gas into the gas filling space 50 provided over the wider range to be located at only one location of the pouch container 1A, thereby simplifying the configuration of the pouch container 1A and the manufacturing process thereof. This facilitates gas injection and facilitates the manufacture of a pouch container with a gas filling space therein.

### First Modified Example

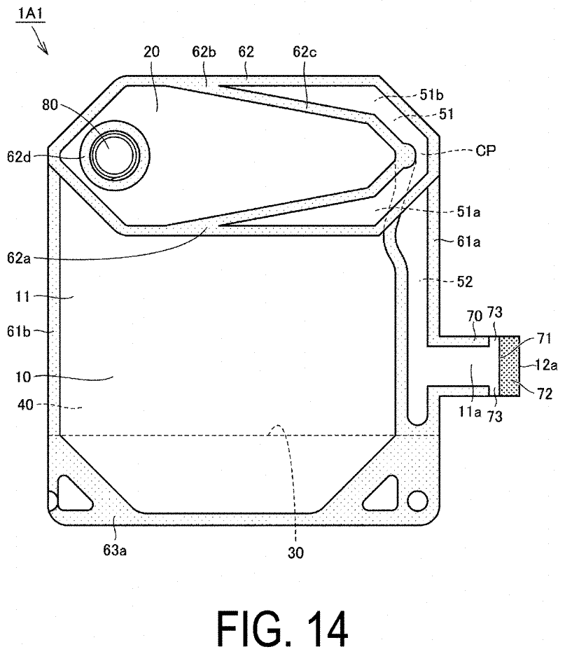

FIG. 14 is a front view of a pouch container according to a first modified example. Referring to FIG. 14, a pouch container 1A1 according to the first modified example based on the first embodiment described above will be described below.

As illustrated in FIG. 14, the pouch container 1A1 according to the first modified example differs from the pouch container 1A according to the first embodiment described above only in terms of the position at which the gas injection portion 70 is formed.

Specifically, in the pouch container 1A1 according to the first modified example, the front wall section 11 as the first wall section includes a first tongue-shaped portion 11a projecting outward from the edge portion of the front wall section 11 at the portion where the first body-section-side seal portion 61a is formed, and the rear wall section 12 as the second wall section includes the second tongue-shaped portion 12a projecting outward from the edge portion of the rear wall section 12 at the portion where the first body-section-side seal portion 61a is formed and overlapping the first tongue-shaped portion 11a. Note that the projection length of the second tongue-shaped portion 12a is formed so as to be longer than the projection length of the first tongue-shaped portion 11a.

By joining both end portions of both the first tongue-shaped portion 11a and the second tongue-shaped portion 12a that overlap each other in the width direction, at the edge portion of the front wall section 11 and the edge portion of the rear wall section 12 at the portion where the first body-section-side seal portion 61a is formed, the gas injection portion 70 having the projection shape formed by the first tongue-shaped portion 11a and the second tongue-shaped portion 12a is provided.

In this configuration, the same effects as those described in the first embodiment described above can be obtained. Thus, in a pouch container having a gas filling space therein, gas injection can be facilitated, and manufacture can be facilitated.

### Second Embodiment

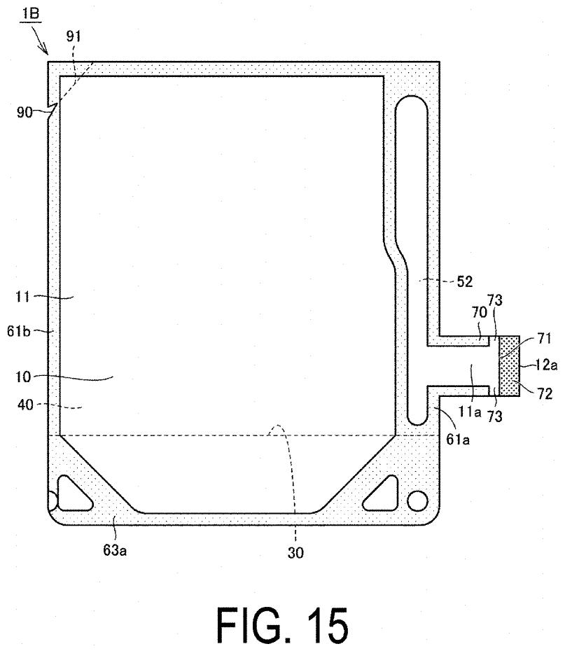

FIG. 15 is a front view of a pouch container according to a second embodiment. A pouch container 1B according to the present embodiment will be described below with reference to FIG. 15.

As illustrated in FIG. 15, the pouch container 1B according to the present embodiment differs from the pouch container 1A according to the first embodiment described above in that the top gusset section 20 is not provided, and the first space 51 of the gas filling space 50 is not provided.

Further, the pouch container 1B according to the present embodiment differs from the pouch container 1A in terms of the position at which the gas injection portion 70 is formed. On the other hand, the position at which the gas injection portion 70 formed in the pouch container 1B and the configuration thereof are similar to those of the pouch container 1A1 according to the first modified example of the first embodiment described above.

In the pouch container 1B, a notch portion 90 is provided at one end of the second body-section-side seal portion 61b in the extension direction, and a half-cut portion 91 is provided that obliquely intersects the pouch container 1B from the notch portion 90 as a starting point. This allows the pouch container 1B to be opened by cutting along the half-cut portion 91 by tearing the pouch container 1B starting from the notch portion 90.

In this configuration, the same effects as those described in the first embodiment described above can be obtained. Thus, in a pouch container having a gas filling space therein, gas injection can be facilitated, and manufacture can be facilitated.

### Second Modified Example

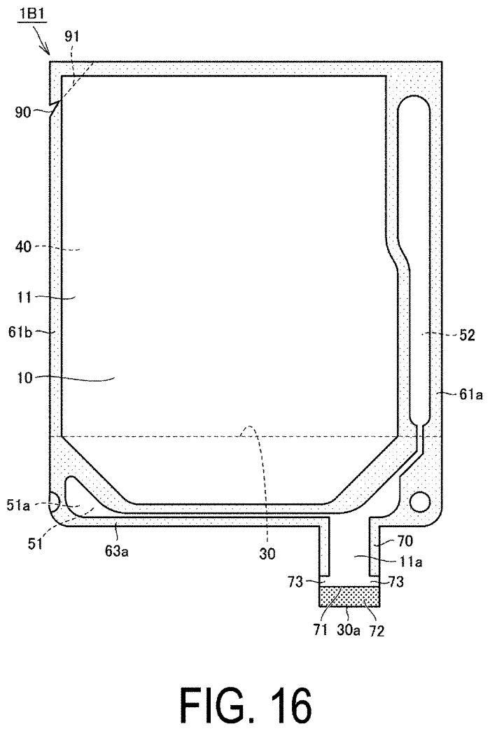

FIG. 16 is a front view of a pouch container according to a second modified example. Referring to FIG. 16, a pouch container 1B1 according to the second modified example based on the second embodiment described above will be described below.

As illustrated in FIG. 16, the pouch container 1B1 according to the second modified example differs from the pouch container 1B according to the second embodiment described above in terms of the configuration of the gas filling space 50 and the gas injection portion 70.

Specifically, in the pouch container 1B1 according to the second modified example, the first space 51 of the gas filling space 50 is provided in the bottom gusset section 30. The front wall section 11 as the first wall section includes the first tongue-shaped portion 11a projecting outward from the edge portion of the front wall section 11 at a portion where the first bottom-gusset-section-side seal portion 63a is formed, and the bottom gusset section 30 as the second wall section includes a second tongue-shaped portion 30a projecting outward from the edge portion of the bottom gusset section 30 at the portion where the first bottom-gusset-section-side seal portion 63a is formed, and overlapping the first tongue-shaped portion 11a. Note that the projection length of the second tongue-shaped portion 30a is formed so as to be longer than the projection length of the first tongue-shaped portion 11a.

By welding both end portions of both the first tongue-shaped portion 11a and the second tongue-shaped portion 30a that overlap each other in the width direction, at the edge portion of the front wall section 11 and the edge portion of the bottom gusset section 30 at the portion where the first bottom-gusset-section-side seal portion 63a is formed, the gas injection portion 70 having the projection shape formed by the first tongue-shaped portion 11a and the second tongue-shaped portion 30a is provided.

In this configuration, the same effects as those described in the first embodiment described above can be obtained. Thus, in a pouch container having a gas filling space therein, gas injection can be facilitated, and manufacture can be facilitated. Further, since the first space 51 is provided in the bottom gusset section 30, deformation of the bottom gusset section 30 can be effectively suppressed.

### Third Modified Example

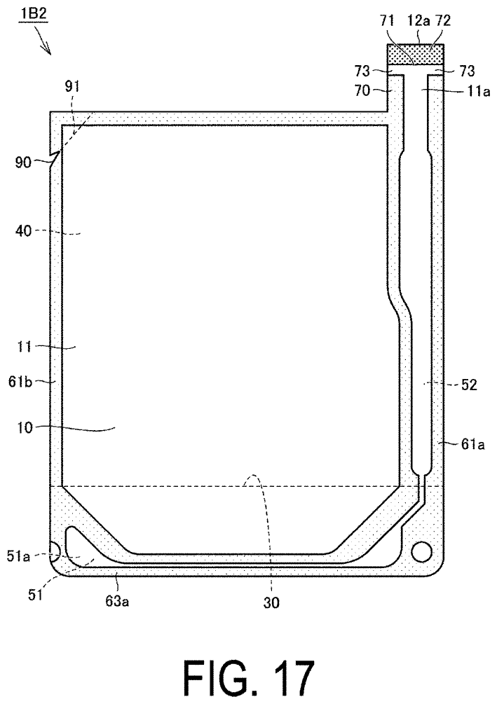

FIG. 17 is a front view of a pouch container according to a third modified example. Referring to FIG. 17, a pouch container 1B2 according to the third modified example based on the second embodiment described above will be described below.

As illustrated in FIG. 17, the pouch container 1B2 according to the third modified example differs from the pouch container 1B according to the second embodiment described above in terms of the configuration of the gas filling space 50 and the gas injection portion 70.

Specifically, in the pouch container 1B2 according to the third modified example, the first space 51 of the gas filling space 50 is provided in the bottom gusset section 30. The front wall section 11 as the first wall section includes the first tongue-shaped portion 11a projecting from the edge portion of the front wall section 11 at the portion where the first body-section-side seal portion 61a is formed toward a side opposite to the side in which the bottom gusset section 30 is located in the axis direction of the pouch container 1B2, and the rear wall section 12 as the second wall section includes the second tongue-shaped portion 12a projecting from the edge portion of the rear wall section 12 at the portion where the first body-section-side seal portion 61a is formed in the same direction as the first tongue-shaped portion 11a and overlapping the first tongue-shaped portion 11a. Note that the projection length of the second tongue-shaped portion 12a is formed so as to be longer than the projection length of the first tongue-shaped portion 11a.

By joining both end portions of both the first tongue-shaped portion 11a and the second tongue-shaped portion 12a that overlap each other in the width direction, at the edge portion of the front wall section 11 and the edge portion of the rear wall section 12 at the portion where the first body-section-side seal portion 61a is formed, the gas injection portion 70 having the projection shape formed by the first tongue-shaped portion 11a and the second tongue-shaped portion 12a is provided.

In this configuration, the same effects as those described in the first embodiment described above can be obtained. Thus, in a pouch container having a gas filling space therein, gas injection can be facilitated, and manufacture can be facilitated. Further, since the first space 51 is provided in the bottom gusset section 30, deformation of the bottom gusset section 30 can be effectively suppressed.

### Third Embodiment

FIG. 18 is a front view of a pouch container according to a third embodiment. A pouch container 1C according to the present embodiment will be described below with reference to FIG. 18.

As illustrated in FIG. 18, the pouch container 1C according to the present embodiment differs from the pouch container 1A according to the first embodiment described above in that the top gusset section 20 and the bottom gusset section 30 are not included, and the first space 51 of the gas filling space 50 is not provided.

The pouch container 1C also differs from the pouch container 1A in that the body section 10 is formed by overlapping and sealing a pair of end portions of the body-section-forming film member having a single sheet-like shape in the width direction. The first body-section-side seal portion 61a and the gas injection portion 70 are formed by this seal portion.

Further, the pouch container 1C according to the present embodiment also differs from the pouch container 1A in terms of the position where the gas injection portion 70 is formed. On the other hand, the position where the gas injection portion 70 is formed in the pouch container 1C and the configuration thereof are similar to those of the pouch container 1A1 according to the first modified example of the first embodiment described above.

In the pouch container 1C, the notch portion 90 is provided at one end of the first body-section-side seal portion 61a in the extending direction, and the half-cut portion 91 intersecting the pouch container 1C in the width direction is also provided adjacent to the notch portion 90. This allows the pouch container 1C to be opened by cutting along the half-cut portion 91 by tearing the pouch container 1C starting from the notch portion 90.

In this configuration, the same effects as those described in the first embodiment described above can be obtained. Thus, in a pouch container having a gas filling space therein, gas injection can be facilitated, and manufacture can be facilitated.

### Other Embodiments

The pouch containers according to the embodiments and modified examples thereof described above can significantly reduce the amount of resin used compared with containers made of a molded resin product. In addition, compared with containers made of a molded resin product, the pouch containers according to the embodiments and the modified examples thereof described above can be folded by removing the gas from the gas filling space after use, and thus can be discarded after the volume has been reduced.

The shapes, configurations, sizes, numbers, materials and the like of the individual portions illustrated in the embodiments and modified examples thereof described above can be changed without departing from the spirit of the present invention.

Further, the characteristic configurations illustrated in the embodiments and the modified examples thereof of the present invention described above can naturally be combined with each other without departing from the spirit of the present invention.

Thus, the embodiments and the modified examples thereof disclosed herein are illustrative and not restrictive. The technical scope of the present invention is defined by the claims, and includes meanings equivalent to those of the claims and all modifications made within the claims.

### REFERENCE SIGNS LIST

1A to 1C, 1A1, 1B1, 1B2 Pouch container
10 Body section
11 Front wall section
11a First tongue-shaped portion
12 Rear wall section
12a Second tongue-shaped portion
20 Top gusset section
20a First tongue-shaped portion
30 Bottom gusset section
30a Second tongue-shaped portion
40 Storage space
50 Gas filling space
51 First space
51a Front-wall-section-side first space
51b Rear-wall-section-side first space
51h Opening
52 Second space
52h Opening
61a First body-section-side seal portion
61b Second body-section-side seal portion
62 Top-gusset-section-side seal portion
62a First top-gusset-section-side seal portion
62b Second top-gusset-section-side seal portion
62c Third top-gusset-section-side seal portion
62d Spout seal portion
63a First bottom-gusset-section-side seal portion
65 Auxiliary seal portion
70 Gas injection portion
71 Injection port
72 Guide portion
73 Non-joined portion
80 Spout
90 Notch portion
91 Half-cut portion
110 Belt-like film member
111 Spout hole
112 Coupling portion
120 Tubular sheet film member
120a Top-gusset-section-side open end
200 Excess portion
CL1, CL2 Cut line
M1 First welding jig
M2 Second welding jig
M3 Third welding jig
M4 Cutting jig
m21 First mold
m22 Second mold
m23 Third mold
m41 Cutting blade

1. A pouch container provided with a storage space for storing contents and a gas filling space that is a space different from the storage space inside the pouch container, the pouch container comprising:
a first wall section and a second wall section having a sheet-like shape and defining the storage space; and
a seal portion formed by overlapping and joining an edge portion of the first wall section and an edge portion of the second wall section, and configured to seal the storage space from outside, wherein
at the edge portion of the first wall section and the edge portion of the second wall section at a portion where the seal portion is formed, a gas injection portion having a projection shape and formed with an injection port communicating with the gas filling space is provided,
the first wall section includes a first tongue-shaped portion projecting outward from the edge portion of the first wall section at the portion where the seal portion is formed,
the second wall section includes a second tongue-shaped portion projecting outward from the edge portion of the second wall section at the portion where the seal portion is formed and overlapping the first tongue-shaped portion,
a projection length of the second tongue-shaped portion is longer than a projection length of the first tongue-shaped portion, and
the gas injection portion is formed by the first tongue-shaped portion and the second tongue-shaped portion by joining both end portions of both the first tongue-shaped portion and the second tongue-shaped portion that overlap each other in a width direction, and the injection port is defined by a tip end portion of the first tongue-shaped portion in a projection direction and the second tongue-shaped portion at a portion facing the tip end portion.

2. The pouch container according to claim 1, wherein both end portions of both the first tongue-shaped portion and the second tongue-shaped portion in the width direction are joined only at root-side portions of the gas injection portion.

3. The pouch container according to claim 2, comprising:
a body section and a gusset section defining the storage space, wherein
one of the first wall section and the second wall section is the gusset section, and
another of the first wall section and the second wall section is the body section.

4. The pouch container according to claim 3, wherein
the gas filling space includes a first space located between the body section and the gusset section, and
the first space is formed surrounded by the seal portion.

5. The pouch container according to claim 4, wherein
the body section includes a front wall section and a rear wall section facing each other, the pouch container further comprising:
a body-section-side seal portion formed by overlapping and joining both edge portions of both the front wall section and the rear wall section in a width direction, wherein
the gas filling space further includes a second space located between the front wall section and the rear wall section, and
the second space is formed surrounded by the body-section-side seal portion and communicates with the first space at an end portion of the body-section-side seal portion on a side of the gusset section.

6. The pouch container according to claim 1, comprising:
a body section and a gusset section defining the storage space, wherein
one of the first wall section and the second wall section is the gusset section, and
another of the first wall section and the second wall section is the body section.

7. The pouch container according to claim 6, wherein
the gas filling space includes a first space located between the body section and the gusset section, and
the first space is formed surrounded by the seal portion.

8. The pouch container according to claim 7, wherein
the body section includes a front wall section and a rear wall section facing each other, the pouch container further comprising:
a body-section-side seal portion formed by overlapping and joining both edge portions of both the front wall section and the rear wall section in a width direction, wherein
the gas filling space further includes a second space located between the front wall section and the rear wall section, and
the second space is formed surrounded by the body-section-side seal portion and communicates with the first space at an end portion of the body-section-side seal portion on a side of the gusset section.

9. A method of continuously manufacturing a plurality of pouch containers, each of the plurality of pouch containers being provided with a storage space for storing contents and a gas filling space that is a space different from the storage space inside each of the plurality of pouch containers, using a single belt-like film member including more than one portion to be a gusset section of each of the plurality of pouch containers and a plurality of tubular sheet film members, each of the plurality of tubular sheet film members including at least a portion to be a body section of each of the plurality of pouch containers as materials, the method comprising:
preparing the plurality of tubular sheet film members;
transporting the single belt-like film member on a transport path along a longitudinal direction of the single belt-like film member;
supplying each of the plurality of tubular sheet film members to the single belt-like film member being transported on the transport path;
closing a gusset section-side open end located at one end of each of the plurality of tubular sheet film members in an axis direction supplied to the single belt-like film member with the portion to be the gusset section of the single belt-like film member; and
after the gusset-section-side open end is closed by the portion to be the gusset section of the single belt-like film member, forming the body section and the gusset section by cutting off an excess portion from a joint margin provided at the gusset section-side open end and the portion to be the gusset section of the single belt-like film member, wherein
in the supplying of each of the plurality of tubular sheet film members to the single belt-like film member, each of the plurality of tubular sheet film members is supplied in a state that the joint margin is expanded and the joint margin is overlapped with the portion to be the gusset section of the single belt-like film member,
in the closing of the gusset-section-side open end by the portion to be the gusset section of the single belt-like film member, a seal portion is formed by joining an edge portion of the joint margin and an edge portion of the portion to be the gusset section of the single belt-like film member being overlapped,
in the forming of the body section and the gusset section by cutting off the excess portion, a gas injection portion is provided in which an injection port that communicates with the gas filling space at the edge portion of the body section and the edge portion of the gusset section at a portion where the seal portion is formed by a first tongue-shaped portion formed at an edge portion of one of the body section and the gusset section and projecting outward from the edge portion and a second tongue-shaped portion formed at an edge portion of the other of the body section and the gusset section, overlapping the first tongue-shaped portion by projecting outward from the edge portion, and having a projection length longer than a projection length of the first tongue-shaped portion, and
when the joint margin is superimposed on the portion to be the gusset section of the single belt-like film member, of the edge portion of the joint margin and the edge portion of the portion to be the gusset section of the single belt-like film member, the edge portion where the second tongue-shaped portion is formed is positioned outside the edge portion where the first tongue-shaped portion is formed, of the edge portion of the joint margin and the edge portion of the portion to be the gusset section of the single belt-like film member, and in the forming of the body section and the gusset section by cutting off the excess portion, by joining both end portions of both the first tongue-shaped portion and the second tongue-shaped portion that overlap each other in a width direction when the seal portion is formed, the injection port is defined by a tip end portion of the first tongue-shaped portion in a projection direction and the second tongue-shaped portion at a portion facing the tip end portion.
